(19) United States
(12) Patent Application Publication
(10) Pub. No.: US 2001/0016845 A1
(43) Pub. Date: Aug. 23, 2001

(54) Method and apparatus for receiving information in response to a request from an email client

(76) Inventor: Bruce Tribbensee, Missoula, MT (US)

Correspondence Address: Judith A. Szepesi, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/733,274

(22) Filed: Dec. 7, 2000

Related U.S. Application Data
(63) Continuation-in-part of application No. 09/468,222, filed on Dec. 20, 1999.
Application No. 09/468,222 is a continuation of application No. 08/798,453, filed on Feb. 10, 1997, now Pat. No. 6,026,410.
(60) Provisional application No. 60/169,539, filed on Dec. 7, 1999.

(51) Int. Cl. G06F 17/30; G06F 15/16

(52) U.S. Cl. 707/10; 709/206; 709/203

(57) ABSTRACT

A method for receiving information and responding to requests is described. The method comprises receiving a message including a request, and identifying a keyword in the message. The method further comprises performing an action based on the keyword in the message, obtaining data responsive to the request, and sending response including the data to the requester.

### RELATED APPLICATIONS

This application claims the benefit of U.S. Provisional Patent Applications, Serial Nos. 60/169,539, filed Dec. 7, 1999, and Serial No. ______ , filed Dec. 7, 1999. This application claims the benefit of U.S. patent application Ser. No. 09/468,222, filed Dec. 20, 1999, which is a continuation application of U.S. Pat. No. 6,026,410, issued Feb. 15, 2000.

### FIELD OF THE INVENTION

The present invention relates to e-mail clients, and more specifically, to obtaining information over a network for an email client.

### BACKGROUND

Two-way pagers are becoming more popular. Users can, in addition to receiving messages and e-mails, send short messages and e-mails. However, the data entry for most two-way pagers is very cumbersome. Thus, sending complicated messages, or browsing the Internet is almost impossible. Additionally, the extremely limited size and resolution of the display mechanism makes displaying Web based information even more complicated. Thus, most pagers do not provide access to information from the Internet. Therefore, a better method of using a tool which permits access to data would be advantageous.

### SUMMARY OF THE INVENTION

A method for receiving information and responding to requests is described. The method comprises receiving a message including a request, and identifying a keyword in the message. The method further comprises performing an action based on the keyword in the message, obtaining data responsive to the request, and sending response including the data to the requester.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of a network on which the present invention may be implemented.

FIG. 2 is a block diagram of one embodiment of a computer system on which the present invention may be used.

FIG. 3 is a block diagram of one embodiment of a client and server systems.

FIGS. 4A-4C are flowcharts of one embodiment of the process, from the client and server perspectives.

FIG. 5 is an exemplary diagram of a connection document.

FIGS. 6-7 are illustrations of a request and a result being displayed.

### DETAILED DESCRIPTION

A method and apparatus for obtaining information using messaging is described. The present invention uses a user input device including an email client, or similar messaging mechanism. The system receives input text expression from the user, including a request for information to be obtained remotely. The messaging mechanism forwards the request to a server.

The server includes a connection document defining keywords to identify a request. The server further includes a parsing device for identifying keyword(s) in the request. Based on the keywords and data identified by the parsing device, a query to one or more addresses is formatted, and transmitted to the appropriate addresses. The response is generally received as HTML. The server extracts the relevant information from the HTML, and generates a response including the relevant information. The server then sends the result to the appropriate place, thus completing the user's request. For one embodiment, the response is an email or message to the requesting client. For another embodiment, the response may be sent to another address, designated in the request. For another embodiment, another type of action may be performed. For example, an item may be purchased, a message may be sent to a third party, or another action may be performed. For one embodiment, if the response is not sent to the user, the user receives an acknowledgement, indicating that the user's request has been completed.

For one embodiment, the server sends the response as a complete web page in text format, in a distilled format returning only the relevant information, in a wireless access protocol format (WAP), or in another format.

In the following description, numerous specific details are set forth in order to provide a thorough understanding of the present invention. However, it will be apparent to one of ordinary skill in the art that these specific details need not be used to practice the present invention. In other circumstances, well-known structures, circuits, and interfaces have not been shown in detail in order to not obscure unnecessarily the present invention.

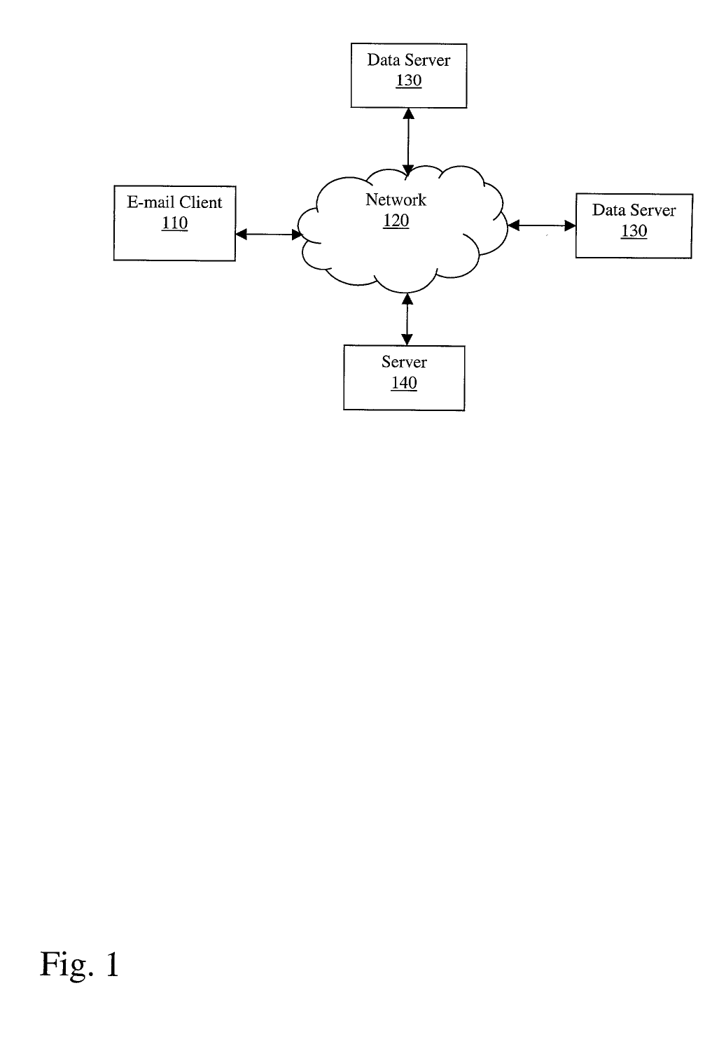

FIG. 1 is a block diagram of a network on which the present invention may be implemented. The client 110 may access the network through a wireless connection, modem, a digital subscriber line (DSL), a local area network (LAN), a wide area network (WAN), or through other means. The network 120 may be an internal large area network (LAN), wide area network (WAN), the Internet, or another network.

The email client 110 may be on a handheld device or a computer system. For one embodiment, the email client 110 may be a conventional email program. For anther embodiment, the email client 110 may be another type of messaging system. For simplicity, for the remainder of this application the term “email client” will refer to any messaging system that permits a user to send a request to a server, and receive a response from the server. In general, the message may be formatted in a mail format, such that the address of the server is the destination address. However, the actual format of the request is irrelevant.

For one embodiment, the handheld device may be a two-way pager, or similar device. The requests from the client device are emailed to a server 140, which is set up to receive such requests. The server 140, in turn, formulates a query or action, in response to the user's request. For example, if the user's request is for data on a data server 130 (such as Amazon's server, or similar), the server 140 forwards the request to the data server 130, in appropriate format, and receives a response. The server 140 then formats the response, and if appropriate includes the response in an email sent to the email client 110.

For one embodiment, the request may be to send certain data to a third party. For example, the request may be to obtain directions from a third party's current location to a known location, and to send the directions to a third party. This may be useful, for example, to send directions to someone who will be visiting. For another embodiment, the request may be to perform some action(s) on a web site. For example, the request may be to purchase a certain book at Amazon.com. The server then performs this action. For one embodiment, the server returns an acknowledgement, indicating that the requested action(s) have been taken.

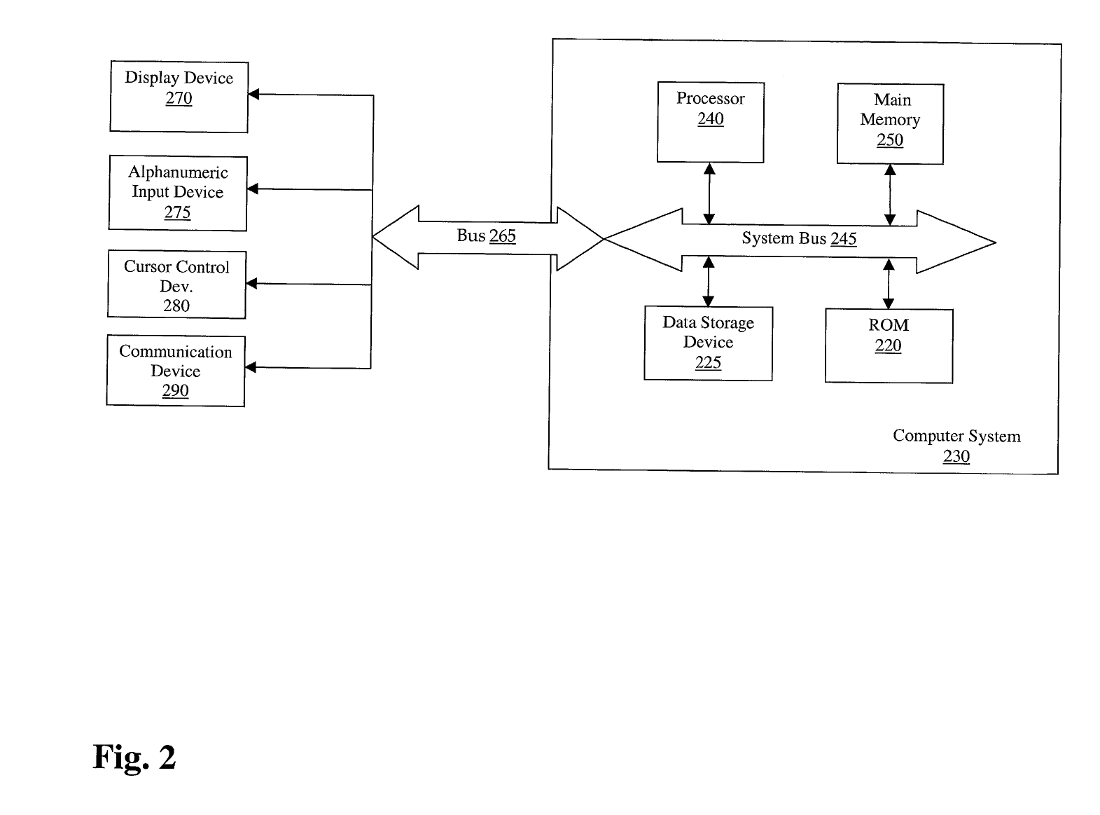

FIG. 2 is a block diagram of one embodiment of a computer system on which the present invention may be used. It will be apparent to those of ordinary skill in the art, however that other alternative systems of various system architectures may also be used.

The data processing system illustrated in FIG. 2 includes a bus or other internal communication means 245 for communicating information, and a processor 240 coupled to the bus 245 for processing information. The system further comprises a random access memory (RAM) or other volatile storage device 250 (referred to as memory), coupled to bus 245 for storing information and instructions to be executed by processor 240. Main memory 250 also may be used for storing temporary variables or other intermediate information during execution of instructions by processor 240. The system also comprises a read only memory (ROM) and/or static storage device 220 coupled to bus 240 for storing static information and instructions for processor 240, and a data storage device 225 such as a magnetic disk or optical disk and its corresponding disk drive. Data storage device 225 is coupled to bus 245 for storing information and instructions.

The system may further be coupled to a display device 270, such as a cathode ray tube (CRT) or a liquid crystal display (LCD) coupled to bus 245 through bus 265 for displaying information to a computer user. An alphanumeric input device 275, including alphanumeric and other keys, may also be coupled to bus 245 through bus 265 for communicating information and command selections to processor 240. An additional user input device is cursor control device 280, such as a mouse, a trackball, stylus, or cursor direction keys coupled to bus 245 through bus 265 for communicating direction information and command selections to processor 240, and for controlling cursor movement on display device 270.

Another device, which may optionally be coupled to computer system 230, is a communication device 290 for accessing other nodes of a distributed system via a network. The communication device 290 may include any of a number of commercially available networking peripheral devices such as those used for coupling to an Ethernet, token ring, Internet, or wide area network. Note that any or all of the components of this system illustrated in FIG. 2 and associated hardware may be used in various embodiments of the present invention.

It will be appreciated by those of ordinary skill in the art that any configuration of the system may be used for various purposes according to the particular implementation. The control logic or software implementing the present invention can be stored in main memory 250, mass storage device 225, or other storage medium locally or remotely accessible to processor 240. Other storage media may include floppy disks, memory cards, flash memory, or CD-ROM drives.

It will be apparent to those of ordinary skill in the art that the methods and processes described herein can be implemented as software stored in main memory 250 or read only memory 220 and executed by processor 240. This control logic or software may also be resident on an article of manufacture comprising a computer readable medium having computer readable program code embodied therein and being readable by the mass storage device 225 and for causing the processor 240 to operate in accordance with the methods and teachings herein.

The software of the present invention may also be embodied in a handheld or portable device containing a subset of the computer hardware components described above. For example, the handheld device may be configured to contain only the bus 245, the processor 240, and memory 250 and/or 225. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of the present invention for such a device would be apparent to one of ordinary skill in the art given the disclosure of the present invention as provided herein.

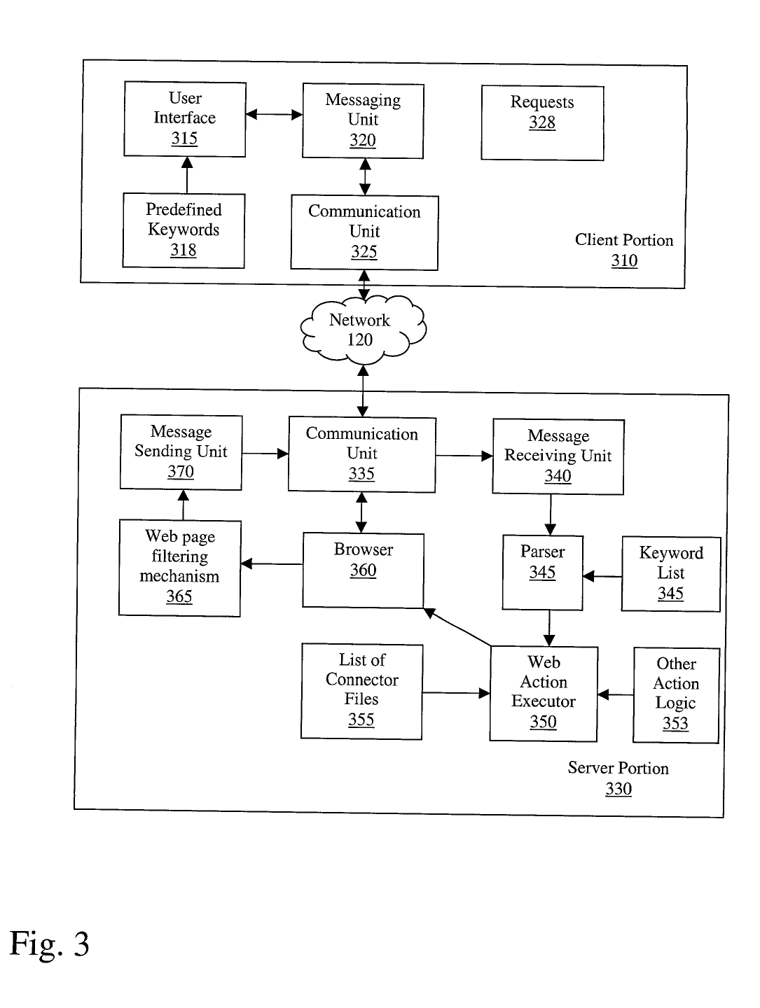

FIG. 3 is a block diagram of one embodiment of a client and server system for the present invention. The block diagram includes the client, which is an email client, and the server. For one embodiment, the server is a dedicated server. Alternatively, any computer connected to the Internet may be set up as a server. Specifically, any computer can run the program described below. This system is illustrated as a server, since it serves the requests from a client. For one embodiment, the client and server portions of the system may reside on the same computer. In other words, a user's computer can include an email client that sends a request, as well as the server to generate a response to the request.

The client portion 310 of the system includes a communications unit 325 that sends the request to the server portion 330 of the system. For one embodiment, the communication unit 325 may be a logic unit that sends data to the server portion 330 of the system, on the same computer. For another embodiment, the communication unit 325 may be a modem, DSL line, or other type of communication logic that permits communication with a server, over a network 120. Alternatively, the communication unit 325 may be a wireless logic that permits the device on which the client portion 310 of the system resides to send out messages. Other systems that permit a request to be sent by the client portion 310 may be used.

A messaging unit 320 is coupled to the communication unit 325. The messaging unit 320 formulates the message to be sent out. The user enters data into user interface 315. For one embodiment, the user enters terms that are predefined keywords, stored in keywords 318. For example, predefined keywords may include terms such as “sq” for stock quote, “dir” for directions, “book” for purchasing a book, etc. For one embodiment, the predefined keywords may also include other entries in the user's system, such as a key words corresponding to the individuals in the user's address book. Thus, for example, BruceT may be the key word for “Bruce Tribbensee” and combined with the keyword “send” the system may interpret this as a request to send certain data to BruceT, via email, or another method.

For one embodiment, after the user composes a request, the message unit 320 verifies that the keywords used are the predefined keywords. In that way, the user does not receive an “error” message because of a simple misspelling. For another embodiment, the keywords may not be included in the client portion 310. In that case, the user would be unable to verify that the keywords used are appropriate. After the user sends the request, via communications unit 325, the communication unit 335 in the server portion 330 of the system receives the request.

For one embodiment, the communication unit 325 in the client also receives a response from the server. For one embodiment, the response may be displayed to the user. For another embodiment, the response may be attached to the original request, but not be automatically displayed. In that case, the next time the user reviews the original request, the response to the request is available. For one embodiment, the requests are filed in a request list 328. For one embodiment, responses are attached to the request, such that a user may always review past requests and responses. For another embodiment, the system pops up the response, when it is received. For one embodiment, the user may set his or her preferences.

The server portion 330 of the system receives requests from the user, via message receive unit 340. Message receiving unit 340 receives the message from the user, and passes it to parser 345. For one embodiment, the parser may be the parser identified in U.S. Pat. No. 6,026,410, incorporated herein by reference.

The parser 345 identifies the keywords in the message. For one embodiment, a message may have any number of key words. Furthermore, the message may define a complex web action. A complex web action requires a series of steps to be performed by the system. For one embodiment, parser 345 is coupled to keyword list 347, which defines each of the keywords, and includes an interpretation.

Thus, for example, if the system receives the message: “sd mp BruceT home”, the keywords “sd” meaning send, “mp” meaning map, “home” meaning the map to the user's home, and BruceT as the destination to whom the response should be sent. Thus, the server portion 330 uses the Action logic 353 to look up a destination associated with BruceT. For one embodiment, the destination is sent by user's system. Thus, while user may enter BruceT as the destination, the user's messaging unit 320 substitutes an address, such as bruce@actioneer.com, for the keyword. In that instance, the server need not look up the destination. For another embodiment, the server may use action logic 353 to look up the mapping of such data. For one embodiment, keyword list 347 identifies each of the possible keywords, and their mapping.

For one embodiment, one or more of the actions indicated by the keywords may be web-based actions. Web-based actions request data not directly available on the server. For example, the purchase of a book, the obtaining of a map, stock quote, or any other context dependent or changing data may be obtained from outside the server. The request is reformatted by web action executor 350, into the proper format. Web action executor 350 reformats the request appropriately, for the destination site. For example, if a book purchase is requested, web action executor 350 knows the destination, and the format required by the designated destination. The connector, in list 355, identifies the actual destination, and the format required for the destination. Connectors may be stored in any format, as a list, as a database entry, or in another type of format. For one embodiment, the connectors may be located on the server, on a remote server fetched by the server when needed. For another embodiment, the connectors may be on the client, and may be sent with the request by the client portion 310 of the system. In that embodiment, the server portion 330 does not need to include list of connectors 355. Rather, the parser detaches the attached connector(s), and passes the data to web action executor 350. Web action executor 350 then uses browser 360 to obtain the requested data, or perform the requested action, on the remote system.

For one embodiment, complex web actions may also be reformatted by web action executor 350. Complex web actions interact with a web site. For example, a complex web action may navigate through a series of web pages, fill out forms, and make selections. For example, a complex web action may fill out a series of pages, to permit a user to make a flight reservation. For one embodiment, a complex web action may decide whether to take a certain action.

For example, a user may send the message “flt SFO to BOS next Friday to Sept 29>$1000. The web action executor 350 would first find the web site, based on the keyword fit, which indicates that a particular web site should be visited. For example, the web site associated with booking flight may be www.expedia.com. The web action executor 350 then navigates through the site, to indicate the departure and arrival airports and dates. This may take navigation through multiple pages. The system then receives the flights that are available for the selected dates. The system then notes that the user wished to book the flight, if the flight cost less than $1000. The web action executor 350 determines if any of the options meets this threshold. If there are actions that meet the threshold, the web action executor 350 purchases the flight requested. For another embodiment, the web action executor 350 may return the options that fit the criteria to the user, to permit the user to make the choice.

If the results are being returned to the user, or being sent to another user, the data received by browser 360 is passed to web page filtering mechanism 365. Web page filtering mechanism 365 reformats the data received in HTML, to pass to the user. For one embodiment, the web page filtering mechanism 365 simply removes extraneous information, such as banner ads, menu items etc. For another embodiment, for users that pay a high rate for bandwidth, or that have a very limited screen display area, the web page filtering mechanism 365 reformats the data to be displayed on the screen. Message sending unit 370 then transmits the message to user.

For one embodiment, if the original request requested an action that did not result in a message being sent to the user, the system sends an acknowledgement, indicating to the user that the request has been performed by the server.

In this way, the server can permit a user on a limited bandwidth and screen size system to perform complex actions, and receive data in response to a user request.

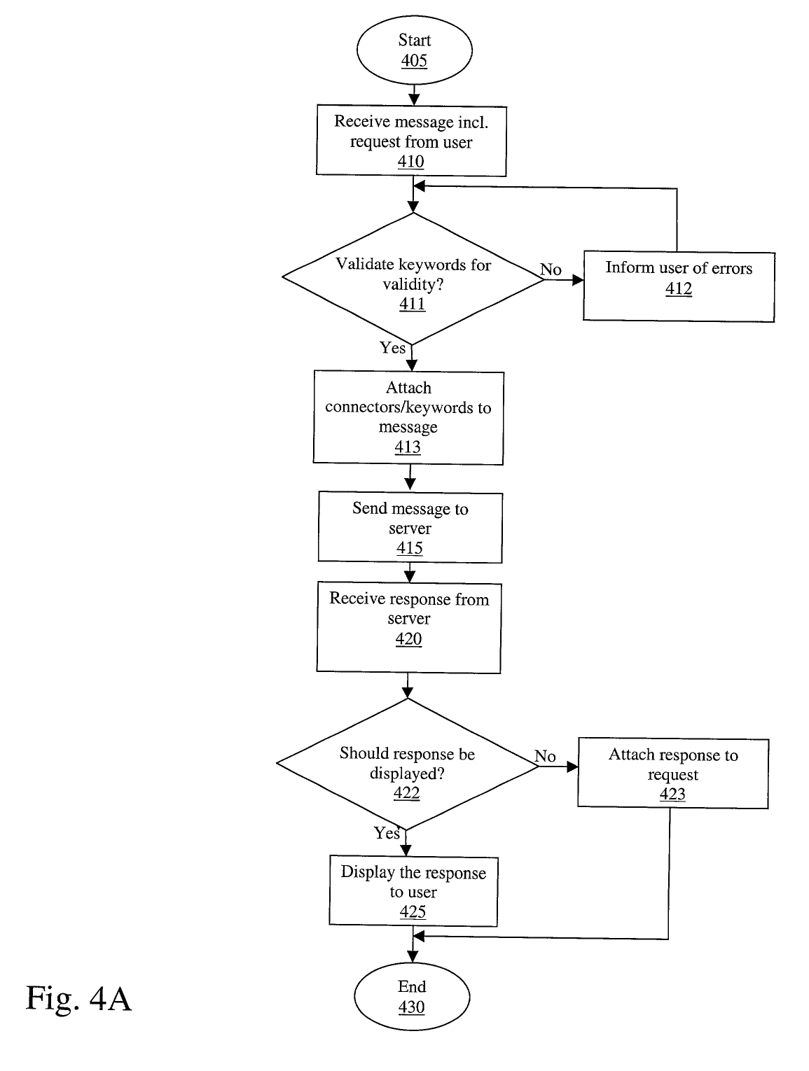

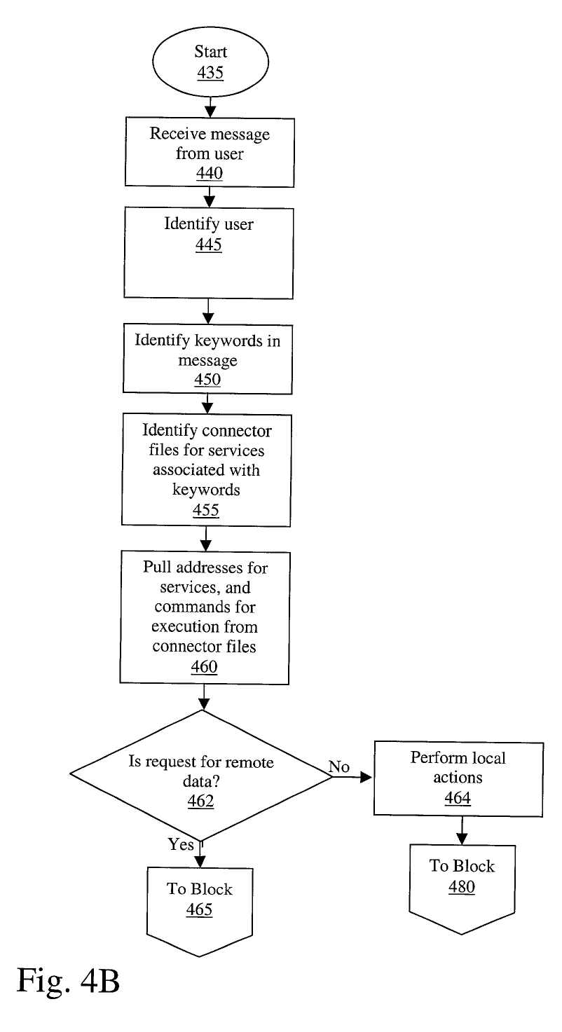

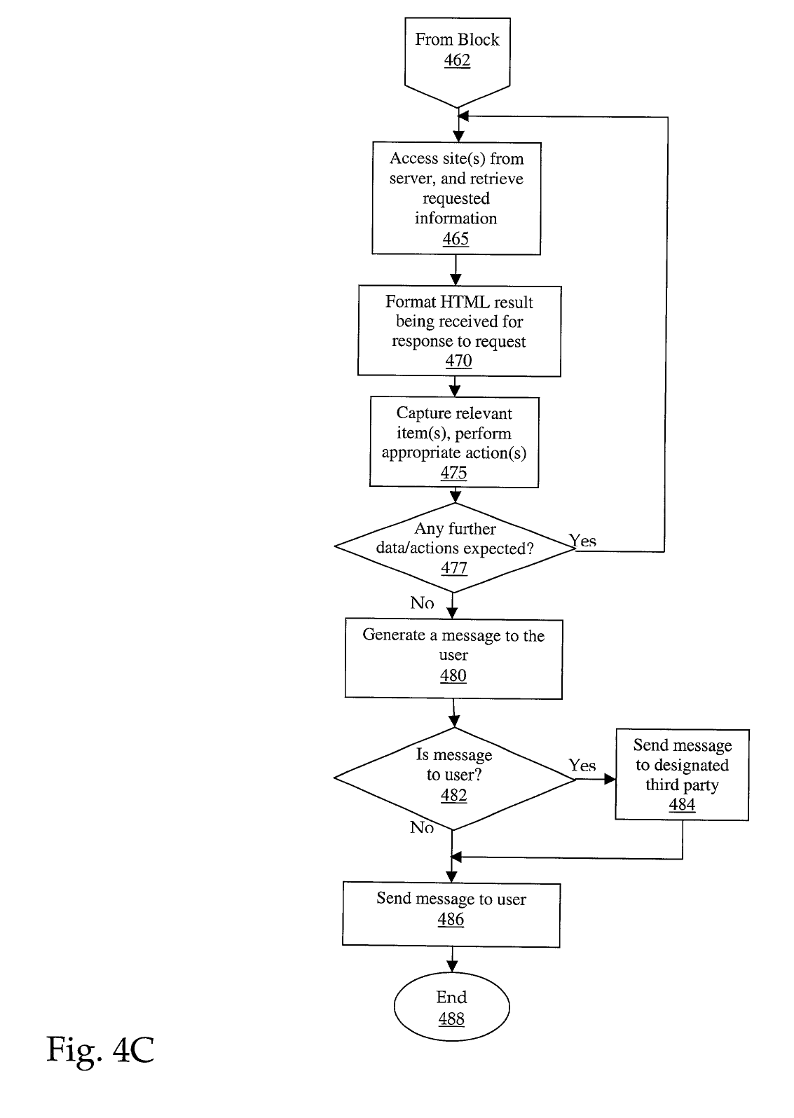

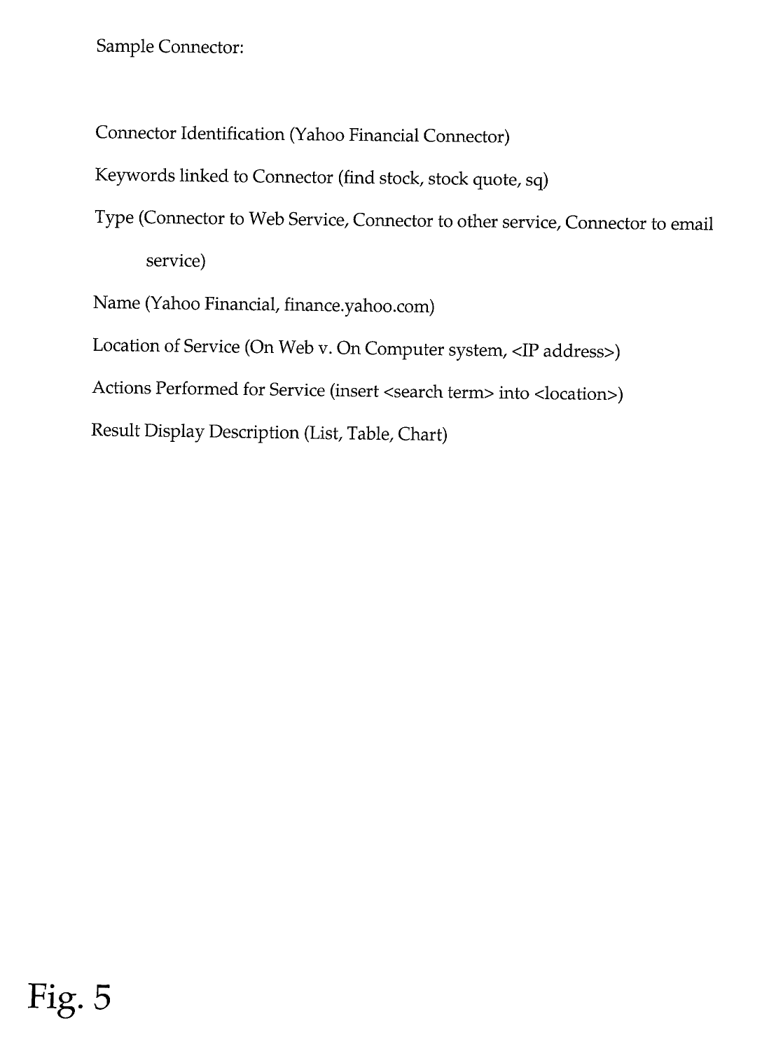

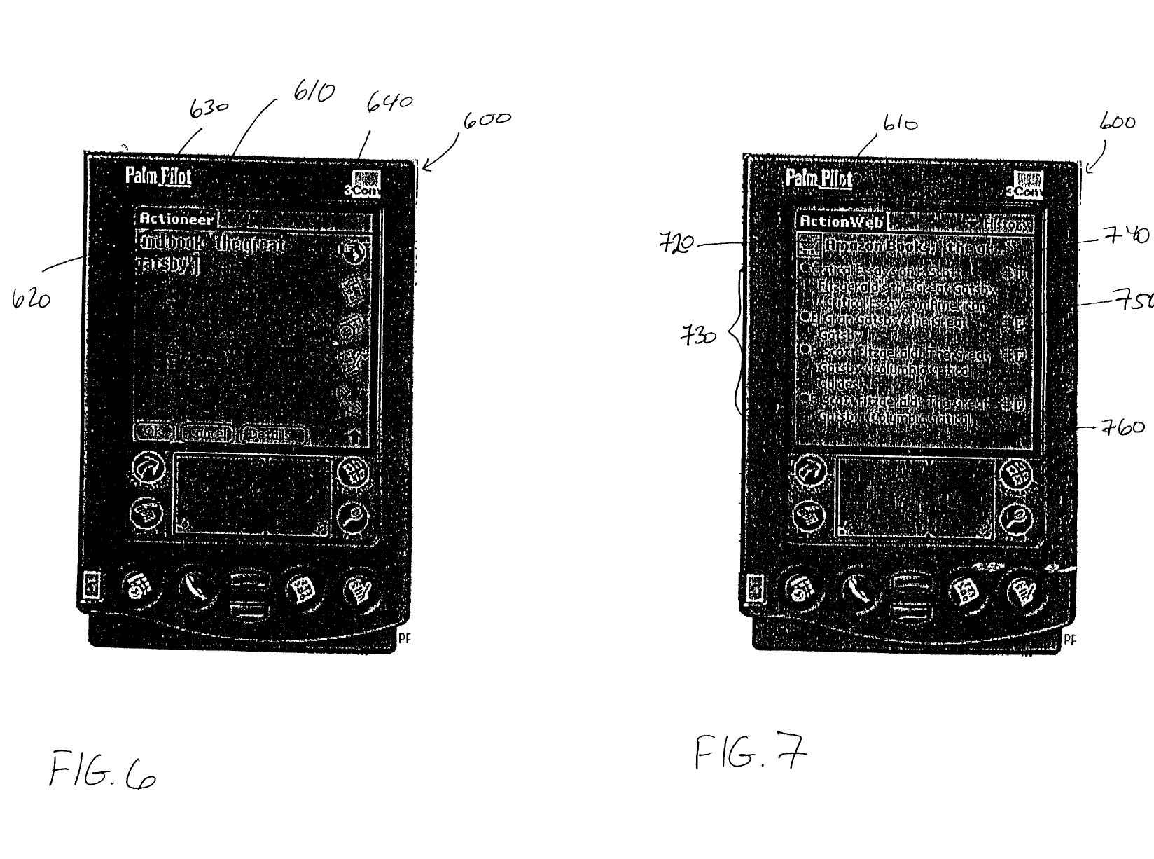

FIGS. 4A-4B is a flowchart of one embodiment of the process, from the clients and the server's perspective. FIG. 4A illustrates the client system. At block 405, the process starts.

At block 410, a message including a request is received from the user. For one embodiment, the user may enter this request into an email program. For another embodiment, the user may enter the request into a notepad or similar mechanism. For one embodiment, there may be a specific “action note” format into which the user can enter the request.

At block 411, the system determines whether the keywords used by the user are known keywords. For one embodiment, the system validates the message, prior to sending the message. If there are unknown terms, for example, if the user misspelled something, the process continues to block 412. At block 412, the user is informed of the issue, and the process returns to block 410, to await the corrected message. For one embodiment, the specific keyword(s) that were incorrect are indicated by underlining or similar highlighting. This permits the user to easily correct the problem.

If the keywords were successfully validated, the process continues to block 413. At block 413, the connectors/keywords are attached to the message. For one embodiment, the keywords and connectors reside on the user's system. In that case, the client system attaches the connectors and keywords that are associated with the message to the message. For another embodiment, this step may be skipped, and the server may look up the keywords itself. For one embodiment, the system only attaches those terms that are referring to user specific data. For example, if the user makes reference to someone else in the user's address book, the process may provide that user's email address, or other contact data. However, for terms that are universal, e.g. keywords and connectors, are not provided.

At block 415, the system sends the message, including any attached keywords or connectors, to the server. For one embodiment, the message may be sent as an email. For another embodiment, the message may be sent in another format, such as WAP, HTTP, or any other format that the user's system can use.

The process then waits for a response from the server. Note that the process does not actually wait, but rather responds when it receives a message from the server.

At block 420, the user receives a response from the server. For one embodiment, the server may respond to a specific request from the user. For another embodiment, the server may send an acknowledgement that an action or actions were performed. For yet another embodiment, this step may be skipped, if no acknowledgement is requested by the user. For one embodiment the acknowledgment preference may be set by the user when he or she is initially configuring their system.

At block 422, the process determines whether the response should be displayed. For one embodiment, it depends on the type of request, whether the response should be displayed. For example, requests for data, such as a stock quote, are immediately displayed. However, requests for other types of information, like the cost of a book may not be displayed. For one embodiment, the keyword has associated with it this preference. For one embodiment, the user may change the preference, at will.

If the response should not be displayed, the process continues to block 423. At block 423 the response is attached to the request. The user can then review the response, by selecting the request, or can search the responses. For one embodiment, acknowledgements are all attached to the request. The process then ends at block 430.

If the response should be displayed, the process continues to block 425, and the response is displayed to the user. The process then ends at block 430. In this way, the present system permits a user to send simplified requests to a server, and have a response sent back.

FIGS. 4B-C illustrate the server's perspective. The process starts at block 435. At block 440, a message is received from a user. For one embodiment, the message may be an email. For another embodiment, another type of message format may be used.

At block 445, the process identifies the user. If the message is an email, then the system identifies the sender of the email. Otherwise, other data may be used. For example, in a wireless message, the packet header may include identifying information.

At block 450, the keywords in the message are identified. For one embodiment, the parser parses the message, and identifies the keywords.

At block 455, the connectors for each of the services associated with the keywords are identified. For one embodiment, if the connectors are attached to the message, then they are detached at this stage, and associated with the appropriate keywords. For another embodiment, if the connectors are stored in the server, the server looks up the keywords found in the message, and retrieves the appropriate connectors.

At block 460, the addresses for the services requested are pulled from the connector, along with the commands. The connector includes the entire chain of actions to be taken by the server, in response to the request. All of this data is pulled at this point, and appropriately formatted. For one embodiment, other data, such as destination address, are also obtained at this point.

At block 462, the process determines whether the request is for remote data. For one embodiment, the request may be for local data, from the server. If the request is for local data, the process continues to block 464. At block 464, the local data is obtained, or other action is performed. The process then continues to block 480.

If, at block 462, the request was found to be for data from an external source, the process continues to block 465. At block 465, the site(s) are accessed, and the requested data is retrieved. As discussed above, this may take navigation through multiple pages, filling in forms, etc.

At block 470, the result from the web page is reformatted for data capture. As noted above, this may be a number of pages into the web site. The result is deemed to be the data which the user requested, or on which the user's actions are to be performed.

At block 475, the relevant data items are captured, and the requested actions are performed. For one embodiment, the user may make a request for data. For example, the user may wish to obtain a stock quote. For another embodiment, the user may make a request for an action. For example, the user may wish to purchase a book from a source.

At block 477, the process determines whether there are further actions to be performed, or data to be captured. If there are not, the process continues to block 480. Otherwise, the process returns to block 465, to access site(s) and retrieve the requested information. For one embodiment, if the additional data to be retrieved is obtained from the same site, the process may instead return to block 470.

At block 480, a reply message is generated, including the relevant data. For one embodiment, if action(s) are performed, the data would include an acknowledgment. For one embodiment, if appropriate, any order numbers or similar data received in response to an action is captured, and included in this response.

At block 482, the process determines whether there is a message to be sent to another, not the requesting user. For one embodiment, in the request, the user can indicate that data should be sent to a third party. If that is the case, the process continues to block 484, and the data is sent to the third party. The process then returns to block 486. If the data is to be sent only to the user, the process continues directly to block 486.

At block 486, a message is sent to the user. If there was a data request, the message includes the requested data. If there was an action request, the message includes an acknowledgement that the action was performed. If the request included a request to send data to a third party, the message includes an acknowledgement that the data was sent. For one embodiment, for requests that do not actually requite a response, this step may be skipped. For another embodiment, the user may configure his or her account to send the acknowledgement messages to a separate location. In that case, the message may be sent anywhere, as configured by the user. For example, the user may not wish to receive acknowledgement on his or her small pager device, but would prefer an email sent to another address. In that instance, the server would send acknowledgements, and all other responses unless specifically indicated, to that email address.

At block 488, the process ends. At this point, the server has performed the user's request. For one embodiment, the server may also perform bookkeeping procedures at this point. Book keeping procedures may include tracking how many requests were made by each user, what the request topic was, which keywords were used etc. For one embodiment, if this service is a for-fee service, the book keeping process may further include adding the request data to the user's bill. Other book keeping procedures, as are known in the art, may be performed.

For one embodiment, the server opens a new thread for each request. If so, when the request is completed, the thread is closed.

FIG. 5 is an exemplary diagram of a connector. Generally, there is only one connector per service. For one embodiment, the connector may be a database entry. Alternatively, the connector may be an independent file. For another embodiment, the connector may be stored in any format. A connector includes several elements.

For one embodiment, the connector includes a type, name, and location of service. (service could be a file on your hard disk, could be a web server) The connector further may include Keywords for the service. The parser uses the keywords to link to the service and determine what subpart of the service (if any) is to be used. For example the keywords “Find Book” links to connectors that have “Find Book” in their set of keywords, and flags on the keyword indicate that the text following the keywords is the text to be used to search for a book.

The connector further includes the Actions to be performed. The actions identified by the connector may be multiple steps. For one embodiment, the system can execute scripts.

The connector further includes a Result display description. This is the part that describes how the results from 2c are to be displayed. It does not necessarily correspond to HTML formatting, but rather, how the results are best displayed on the small device screen. For example—a Yahoo.com stock quote has results that are formatted in an HTML table for a big screen. The system watches for that table (using tags as described above) and pulls out result items. However, displaying them in a table on the handheld device is generally not optimal, because of the limited amount of space. Therefore, the Result display description may indicate that the information should be displayed in a list. The connector specifies that each item pulled from the stream based on the keys in 2c should be displayed as consecutive items in a list.

As a result of this format of displaying, the process does not need to wait for the document to complete downloading. Rather, as soon as the next item is received, it can be displayed. This reduces the wait for results considerably.

The connector documents are analogous to “plug-ins” but differ in that they do not necessarily have code in them. For one embodiment, connectors may include Java or c++ DLL.

The connector documents are installed or updated in one of several ways

a) They are preinstalled with the software (the default connectors) These may be code resources or documents in a directory, or records in a database. The handheld has preinstalled connectors in both resources and database record entries.

b) They can be installed by the user (drag and drop on desktop software, conduits for handheld software).

c) They can be fetched by the software periodically (manually or automatically) from a central “catalog” server.

d) They can be updated by the software at a location specified in a connector. For example, a service could put in a connector a field that says “check this URL every three days for a newer connector”.

If there is a catalog server, the connectors may be produced by the catalog server in many ways. For one embodiment, the catalog server has files in a folder that it sends directly to the client software. For one embodiment, the files may be in XML, so that a single connector source file may produce several different versions of the same connector depending on which version of our client is requesting it. For example—if the Windows 3.0 desktop client requests a new version of a connector, the XML style-sheet will produce an XML document that has the expected fields for that version. If the handheld client asks for a new version, the style-sheet will produce a document with the sections used to describe the results display.

FIGS. 6-7 are illustrations of a request and a result being displayed. The example shows an email message, with its subject line being the request, including a keyword, sq. The response from the server, also in email format is shown in FIG. 7. As can be seen, the subject is not changed, and the body of the message includes the response to the user's request. In this case, the body of the message includes the data about the stock quote requested. Alternative methods of displaying this data would be obvious to one skilled in the art. For example, for another type of device, an actual stock graph may be made available, tables may be used, etc.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
receiving a message including a request;
identifying a connector based on a keyword in the message;
performing an action identified by the connector;
sending a response including the data to the requester.

2. The method of claim 1, wherein the message is an electronic mail message.

3. The method of claim 1, wherein performing an action comprises:
accessing a web page identified by the connector; and
filling in a form on the web page.

4. The method of claim 1, wherein performing an action comprises:
accessing a web page identified by the connector; and
obtaining data from the web page.

5. The method of claim 1, wherein performing an action comprises:
accessing a web page identified by the connector; and
downloading data from the web page.

6. The method of claim 1, further comprising:
identifying a keyword in the request designating a destination for the response; and
sending the response to the destination.

7. The method of claim 6, further comprising:
sending an acknowledgement to an originator of the request, after the response is sent to the destination.

8. The method of claim 1, wherein the keyword indicates one or more of the following: an action to be performed, data to be downloaded, and a destination for a response to the request.

9. An apparatus comprising:
a parser to identify a keyword in a message received from a user;
a connector file to indicate an action associated with the keyword;
an action logic to perform the action; and
a response logic to send a response with a result from the action to the user.

10. The apparatus of claim 9, wherein the message and the response are email messages.
